(19) United States
(12) Patent Application Publication
(10) Pub. No.: US 2003/0219359 A1
(43) Pub. Date: Nov. 27, 2003

(54) Pipette tip

(76) Inventors: Jurgen Lenz, Hamburg (DE); Peter Molitor, Henstedt-Ulzburg (DE); Michael Schicke, Kaltenkirchen (DE)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/430,145

(22) Filed: May 6, 2003

(30) Foreign Application Priority Data
May 22, 2002 (DE) 102 22 511.7

(51) Int. Cl. B01L 3/02

(52) U.S. Cl. 422/100

(57) ABSTRACT

A pipette tip having an elongate, tubular body which has a pipetting aperture at one end and a placement aperture at the other end for placement on a receiving shank of a pipetting device, which is encompassed by an axially directed, inwardly inclined circumferential sealing lip which, at its base, is connected to the tubular body and can be elastically flared by placement on the receiving cone.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

Pipette tips, along with pipetting devices, are used for proportioning liquids. Pipette tips have an elongate, tubular body which has a pipetting aperture at one end and a placement aperture at the other end for placement on a receiving shank of a pipetting device. The receiving shank ist mostly of a conical shape. However, cylindrical receiving shanks are also known. Additionally, there are conical or cylindrical receiving shanks which have circumferential bulges or the like to intensify the seal-ing or clamping action.

The pipetting device comprises a gas displacement device which mostly is designed as a piston-and-cylinder unit. The gas displacement device is connected to a through opening of the receiving shank. The pipette tip is fixed by forcing the receiving shank into the placement aperture on the pipetting device.

The gas displacement device is used for displacing a gas column to draw in a liquid into the pipette tip placed on top of the receiving shank or to expel it from the tip. When the gas column is shifted away from the pipette tip a certain volume of liquid is drawn into the tubular body through the pipetting aperture. When the gas column is shifted towards the pipette tip the volume of liquid is dispensed from the tubular body through the pipetting aperture. The pipette tip is forced off the receiving shank by means of a throw-off device which acts onto the upper edge of the pipette tip.

The pipetting device may be a hand-operated pipette or proportioning station with the gas displacement device actuated by hand or driven by a motor. The placement and throw-off of the pipette tip may also be manual or be driven by a motor.

The pipette tip requires to be sealingly fixed to the receiving shank to avoid faulty pipetting. Furthermore, the forces for placing the pipette tip on the receiving shank and throwing it off therefrom should not bee too large. The procedure of fixing pipette tips to a receiving shank is very sensitive to dimensional variations. Any variations of the dimensions of the receiving shaft or pipette tip, e.g. with regard to the cone angle and/or cone diameter, will result in large reception and throw-off forces in one extreme. In the other extreme, the pipette tip will not hold on the receiving shank or the joint between the pipette tip and receiving shank will lack tightness. If the pipette tips use receiving shanks having additional elastic sealing elements (e.g. moulded parts, O-ring seals) the sealing elements are subjected to heavy wear.

Pipette tips which are known already are those which have one or more circumferential sealing bulges on the placement aperture at the inner circumference of the tubular body to control the sealing and clamping function (U.S. Pat. No. 6,168,761 B1, U.S. Pat No. 6,248,295 B1). Any tolerance compensation is only possible under certain conditions because of the considerable deformations and forces occuring in the sealing zone.

Pipette tips which also are known already are those in which the tubular body has a weakened wall thickness to promote an elastic flare and accommodation to the receiving shank (U.S. Pat No. 4,961,350, U.S. Pat No. 4,072,330). This is why another reduction in tolerance sensitivity is also desirable under this consideration.

### BACKGROUND SUMMARY OF THE INVENTION

Accordingly, it is the object of the invention to provide a pipette tip which achieves adequate sealing against a receiving shank when the placement and throw-off forces diminish and tolerance sensitivity is lower.

The object is achieved by a pipette tip having the features of claim 1. It further is achieved achieved by a pipette tip having the features of claim 3. Advantageous aspects are indicated in the sub-claims.

The first version of the inventive pipette tip has a an elongate, tubular body which has a pipetting aperture at one end and a placement aperture at the other end for placement on a receiving shank of a pipetting device, which is encompassed by an axially directed, inwardly inclined circumferential sealing lip which, at its base, is connected to the tubular body and can be elastically flared by placement on the receiving cone.

The pipette tip is conventionally received and oriented by the receiving shank. The sealing and fixing functions are substantially performed by the sealing lip which is elastically flared while the pipette tip is placed on top of the receiving shank. As a result, the inward inclination of the sealing lip (i.e. towards the pipette axis) helps achieve a particularly large elastic deformation on the placement aperture the result of which is an improved tolerance compensation. Since the sealing lip is inwardly inclined, if the sealing lip is of an appropriate elastic design, the elastic deformations achieved are significant and will result in a tolerance compensation so that sealing desired will be ensured while the pipette tip is securely seated on the receiving shank.

In a conical receiving shank, the flare of the sealing lip increases with an increase in the penetration depth of the placement cone and will not reach its maximum value before the end of the placement motion. This makes placement easier. To this end, an aaccomodation of the pipette tip and the receiving cone may additionally ensure that the sealing lip is elastically flared only in the course of placement after the receiving cone has penetrated already into the placement aperture. If it is placed on top of a cylindrical receiving shank the sealing lip will be flared already at the beginning of the placement motion, which can be controlled by a conical insertion aperture at the end of the sealing lip. In any case, however, the significant elastic flare of the sealing lip will ensure that tolerances not to affect the sealing and placement and provide for throw-off forces to remain small. If the pipette tip is designed as an expendable article a new sealing lip will be employed every time the pipette tip is exchanged so that sealing needed is always ensured unlike for the con-ventional additional elastic sealing elements on the sealing shank.

According to an aspect, the sealing lip is separated by a circumferential slot from a shell portion of the tubular body. In particular, the shell portion may serve as a base for attaching a throw-off device for the pipetting device. It also can limit a deformation of the sealing lip, this stabilizing the seating of the pipette tip on the receiving cone.

The second version of the inventive pipette tip has an elongate, tubular body which has a pipetting aperture at one end and a placement aperture at the other end for placement on a receiving shank of a pipetting device which is encompassed by an axially directed circumferential sealing lip which, at its base, is connected to the tubular body and can be elastically flared by placement on the receiving cone, and which is separated by a circumferential slot from a shell portion of the tubular body.

In this design version, the circumferential slot results in increased elasticity in the area of the sealing lip, the consequence of which is adequate sealing against a receiving shank when the placement and throow-off forces diminish at a lower tolerance sensitivity. In particular, the shell portion may serve as a base for attaching a throw-off device for the pipetting device. It can also limit a deformation of the sealing lip, this stabilizing the seating of the pipette tip on the receiving cone. In this version, the sealing lip may particularly be oriented in parallel with the pipette axis or may be inclined away from the pipette axis or may be inclined towards the pipette axis.

According to an aspect, the shell portion has a collar which is circumferential around the placement aperture. The collar may particularly serve for retaining the pipette tip to the edge of a reception aperture of a tip carrier. When placed on a receiving shank, the pipette tip may be supported with the collar on the tip carrier.

According to an aspect, the sealing lip has a circumferential bulge at the inside of its free end that will bear on the shell of the receiving shank so as to seal particularly well because of the increased surface pressure.

According to an aspect, the sealing lip has its base at the maximum inner diameter of the tubular body, which makes it easier to introduce the receiving shank into the placement aperture.

According to an aspect, the pipette tip is integrally made. According to an aspect, the pipette tip is made of a plastic material. Generally, it may be manufactured from several different plastic materials, e.g. a particularly elastic plastic material in the sealing lip area and from a less elastic plastic material, for the rest.

According to an aspect, the pipette tip is made of a single plastic material (e.g. polypropylene or polyethylene). Here, a particular elasticity of the sealing lip may specifically be ensured by giving it a wall thickness smaller than that of the tubular body. It is preferred that the sealing lip has a wall thickness which is about 50% of that of the tubular body, as a maximum.

According to an aspect, the pipette tip has a stopper to limit the depth of penetration of the receiving shank. For instance, the stopper may be formed by an inside step in the pipette tip below the sealing lip against which the stopper abuts its front face, which limits the depth of penetration of the receiving shank.

### BRIEF DESCRIPTION OF THE SEVERAL VIEWS OF THE DRAWINGS

The invention will be described in more detail below with reference to the accompanying drawing of an embodiment. In the drawing:

FIG. 1 shows the pipette tip in a longitudinal section;

FIG. 2 shows an enlarged partial section II of the same pipette tip.

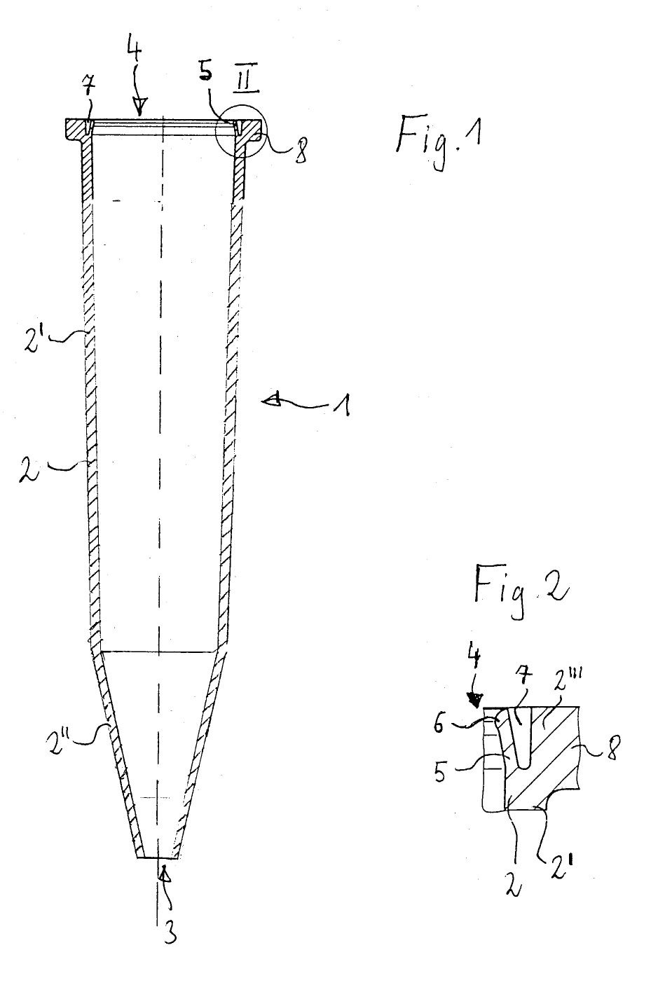

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

A pipette tip 1 has an elongate, tubular body 2 which has a slightly conical main portion 2′ and a more pronouncedly conical end portion 2″ in the example.

The tubular body 2 has a pipetting aperture 3 at one end and a placement aperture 4 at the other end for placement on a receiving shank of a pipetting device.

The placement aperture 4 is encompassed by a sealing lip 5 which, extending from its base at which it is connected to the tubular body 2, is axially directed to the placement aperture 4 with an inward inclination to the central axis of the tubular body 2. The sealing lip 5 has a circumferential bulge 6 at the inside of its free end.

The sealing lip 5 has its base at the maximum inner diameter of the tubular body. It is separated by an axially directed slot 7 from a shell portion 2′″ of the tubular body 2 which, in turn, has a circumferential collar 8.

The entire pipette tip 1 is integrally injection moulded from a single plastic material.

When the placement aperture 4 of the pipette tip 1 is placed on a receiving cone of a pipetting device the sealing lip 5 will be flared during the introduction procedure, which ensures that the pipette tip 1 is sealingly and fixedly seated on the receiving cone. Dimensional tolerances of the receiving cone and pipette tip 1 are compensated by the considerable expandability of the elastic sealing lip 5. Placement and throw-off forces will be low because of this elasticity.

The above Examples and disclosures are intended to be illustrative and not exhaustive. These examples and description will suggest many variations and alternatives to one of ordinary skill in this art. All these alternatives and variations are intended to be included within the scope of the attached claims. Those familiar with the art may recognize other equivalents to the specific embodiments described herein which equivalents are also intended to be encompassed by the claims attached hereto.

What is claimed is:

1. A pipette tip having an elongate, tubular body (2) which has a pipetting aperture (3) at one end and a placement aperture (4) at the other end for placement on a receiving shank of a pipetting device, which is encompassed by an axially directed, inwardly inclined circumferential sealing lip (5) which, at its base, is connected to the tubular body (2) and can be elastically flared by placement on the receiving cone.

2. The pipette tip as claimed in claim 1 wherein the sealing lip (5) is separated by a circumferential slot (7) from a shell portion (2′″) of the tubular body (2).

3. A pipette tip having an elongate, tubular body (2) which has a pipetting aperture (3) at one end and a placement aperture (4) at the other end to be placed on a receiving shank of a pipetting device, which is encompassed by an axially directed circumferential sealing lip (5) which, at its base, is connected to the tubular body (2) and can be elastically flared by placement on the receiving cone, and which is separated by a circumferential slot (7) from a shell portion (2′″) of the tubular body (2).

4. The pipette tip as claimed in claim 2 wherein the shell portion (2′″) has a collar (8) which is circumferential around the placement aperture (4).

5. The pipette tip as claimed in claim 1 wherein the sealing lip (5) has a circumferential bulge (6) at the inside of its free end.

6. The pipette tip as claimed in claim 1 wherein the sealing lip (5) has its base at the maximum inner diameter of the tubular body (2).

7. The pipette tip as claimed in claim 1 which is integrally made.

8. The pipette tip as claimed in claim 1 which is manufactured from a plastic material.

9. The pipette tip as claimed in claim 8 which is made of a single plastic material.

10. The pipette tip as claimed in claim 1 wherein the sealing lip (5) has a wall thickness smaller than that of the tubular body (2).

11. The pipette tip as claimed in claim 1 which has a stopper to limit the depth of penetration of the receiving shank.
